(19) United States
(12) Patent Application Publication
(10) Pub. No.: US 2013/0110293 A1
(43) Pub. Date: May 2, 2013

(54) REMOTELY-CONTROLLED WATER SPRINKLING SYSTEM AND METHOD

(71) Applicant: Harald Illig, Salt Lake City, UT (US)

(72) Inventor: Harald Illig, Salt Lake City, UT (US)

(21) Appl. No.: 13/663,223

(22) Filed: Oct. 29, 2012

Related U.S. Application Data
(60) Provisional application No. 61/553,322, filed on Oct. 31, 2011.

(51) Int. Cl. A01G 25/16

(52) U.S. Cl. CPC A01G 25/16
USPC 700/284

(57) ABSTRACT

An apparatus and method for remotely controlling water sprinkling systems is disclosed. Computing devices such as smart phones, personal computers, and the like may be connected to the Internet and run programs to control water sprinkling systems. A controller may be provided that communicates with the computing device and activates and deactivates solenoids within an existing sprinkling system. The remote computing device is used to set parameters for watering schedules, etc. and communicate them wirelessly to the controller. The controller may also have access to the internet for local weather reports and activate or deactivate the sprinkling system based on the local weather reports.

### THE FIELD OF THE INVENTION

The present invention relates to devices and methods for remotely-controlling water sprinkling systems. More specifically, the present invention relates to using smart phones, personal computers, tablets, and the like, for controlling water sprinkling systems.

### BACKGROUND

Aboveground lawn sprinklers are commonly used to irrigate lawns and plants. Various methods have been provided to control water sprinkling systems. For example, mechanical devices may be used. Electronic devices are growing more popular, but these electronic sprinkler controllers are often confusing and more difficult to operate than the mechanical devices they have replaced.

Modern automatic lawn sprinkling controllers command irrigation by setting times and duration of water delivery. They usually have a small LCD display and buttons, or rotary switches, or both. The user must cycle through a pre-set sequence of menu options and settings in order to encounter all the necessary settings for activating the device's functions. Often these lawn sprinkling controllers are mounted outdoors or in a garage or in dark corners amongst clutter or at awkward heights and viewing angles so that such small LCD displays are inconvenient to see and use. With existing modern automatic lawn sprinkling controllers, often only a few of the irrigation parameters that need to be set and viewed can be displayed on a small LCD screen at one time. These controllers do not display all pertinent information on a ubiquitous user-friendly device.

Moreover, while these devices may be able to account for soil moisture and respond accordingly, the device does not account for special irrigation conditions such as weather forecasts.

### SUMMARY OF THE INVENTION

The present invention provides a method for remotely controlling a sprinkling system comprised of selecting a computing device capable of sending information remotely via the internet; selecting a controller with an input port for receiving information from the computing device, a microprocessor, and an output port for providing an electrical current to an irrigation solenoid; and entering inputs for watering schedules on the computing device.

The method may further comprise pairing the computing device and the controller by setting a matching access code on the computing device and controller.

By way of example, the computing device may be selected from the group of smart phones, mobile phones, tablets, laptops, desktops, home entertainment devices, and home gaming devices.

Furthermore, the controller may access the internet and the method further comprises the controller accessing the internet to check for local weather reports and process the reports, and the send an electrical current on the output port based on the local weather report.

The microprocessor of the controller may also be programmed to suppress watering if rain is predicated in the local weather report and increase watering time if hot temperatures are predicted in the local weather report.

Sprinkling systems at multiple physical locations may be controlled by the computing device, with each of the multiple physical locations having at least one controller.

The remote computing device may comprise software with inputs for multiple irrigation stations and the controller comprises multiple output ports for each of the multiple irrigation stations.

The computing device and the controller may exchange data and a binary code, the binary code having a section designating the latest version of the software, allowing the controller to automatically update its version of the software whenever a newer version of software on the computing device is detected. The computing device may download the latest software version from the internet.

An apparatus for providing remote control of a water sprinkling system may comprise an input port for receiving and storing information regarding water scheduling times, the information including at least a desired start time and stop time for irrigation; a microprocessor connected to the input port and an output port; the output port for sending an electrical signal to at least one irrigation station.

The apparatus may further comprise an input port for receiving and storing information regarding soil moisture sensor readings. The apparatus may include a Wi-Fi chip, USB port, Ethernet port, or other means for sending information wirelessly. The apparatus also includes a port for electrical connection to at least one irrigation station.

A system is provided to remotely control irrigation systems, a computing device with Wi-Fi or Internet capabilities to send information, and a controller with an input port for receiving information from the computing device, an output port for sending electrical signals to at least one irrigation station, and a microprocessor connected to the input port and output port.

The system may control multiple irrigation systems using at least two controllers located at at least two physical locations. Each of the controllers may have a unique access code, and the computing device may be programmed to pair to each unique access code.

A computer program product comprising a computer readable storage medium to store a computer readable program that causes the computer to perform operations for remotely controlling a sprinkling system. Such operations include receiving an input from a user at a computing device, wherein the input comprises an instruction for remotely controlling a controller of the sprinkling system, transmitting the instruction from the computing device to the controller, and receiving at the computing device feedback information from the controller, wherein the feedback information indicates a status of at least one operating condition at the controller.

The operations may further include receiving a pairing input from the user at the computing device, wherein the pairing input comprises an access code to match a corresponding access code of the controller, enabling a communication of the access code of the computing device or the corresponding access code of the controller between the computing device and the controller, and pairing the computing device with the controller in response to verification of a match between the access code of the computing device and the corresponding access code of the controller.

The operations may also include accessing a local weather report via the internet, and transmitting the instruction from the computing device to the controller in response to a parameter of the local weather report meeting a sprinkler adjustment criterion. The operations may also include sending instructions from the computing device to a plurality of controllers to control a corresponding plurality of sprinkling systems.

The operations of the computer program product may include displaying a station control screen on a user interface of the computing device, the station control screen being configured to visually display parameters of a watering schedule for a plurality of watering stations controlled by the controller, and receive the input from the user to adjust at least one of the parameters of the watering schedule.

These and other aspects of the present invention are realized in a remotely controlled water sprinkling system and method of use as shown and described in the following figures and related description.

### BRIEF DESCRIPTION OF THE DRAWINGS

Various configurations of the present invention are shown and described in reference to the numbered drawings wherein:

FIG. 1 shows a block diagram of the remotely controlled watering system;

FIG. 2A shows a perspective view of the controller;

FIG. 2B shows a rear view of the controller of FIG. 2A;

FIG. 3 shows an example of a station control screen on a smart phone;

FIG. 4 shows an example of a moisture display screen;

FIG. 5 shows an example of a physical location screen;

FIG. 6 shows an example of a calendar watering schedule;

FIG. 7 shows an example of a setup screen;

FIG. 8 shows an example of an access code error screen;

FIG. 9 shows an example of a Wi-Fi setup screen;

FIG. 10 shows an example of an advanced setup screen;

FIG. 11 shows the overall logic on the remote computing device and the controller;

FIG. 12 shows the logic of the main procedure of the computing device;

FIG. 13 shows the logic of the first initialization of the application on the computing device;

FIG. 14 shows the logic of the computing device writing to screens;

FIG. 15 shows the logic of the computing device getting settings from screens;

FIG. 16 shows the logic of the main procedure of the controller; and

FIG. 17 shows the logic of the controller action.

It will be appreciated that the drawings are illustrative and not limiting of the scope of the invention which is defined by the appended claims. The configurations shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment or configuration need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

Many of the functional units described in this specification have been labeled as modules, or equivalent functional units, in order to more particularly emphasize their implementation independence. Modules are at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented using software, stored on a physical storage device (e.g., a computer readable storage medium), for execution by various types of processors. Reference to a computer readable storage medium may take any physical form capable of storing machine-readable instructions, at least for a time in a non-transient state, on a digital processing apparatus. Examples of a computer readable storage medium include, but are not limited to, a semiconductor or solid state memory, magnetic tape, a removable computer diskette, a random access memory (RAM), a read-only memory (ROM), a Bernoulli drive, ARDUINO, a magnetic disk, flash memory, integrated circuits, or other digital processing apparatus memory device, and an optical disk. Current examples of optical disks include a compact disk with read only memory (CD-ROM), a compact disk with read/write (CD-R/W), and a digital video disk (DVD).

An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices which are referred to herein as computer readable media and/or electronic data storage devices.

In some embodiments, the software portions are stored in a non-transitory state such that the software portions, or representations thereof, persist in the same physical location for a period of time. Additionally, in some embodiments the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM) which can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of embodiments of the invention may be combined in any suitable manner in one or more embodiments. In the following description, numerous specific details are provided, such as examples of programming, software modules (stored on a physical device), user selections, network transactions, database queries, database structures, hardware modules, hardware circuits, hardware chips, etc., to provide a thorough understanding of embodiments of the invention. One skilled in the relevant art will recognize, however, that embodiments of the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

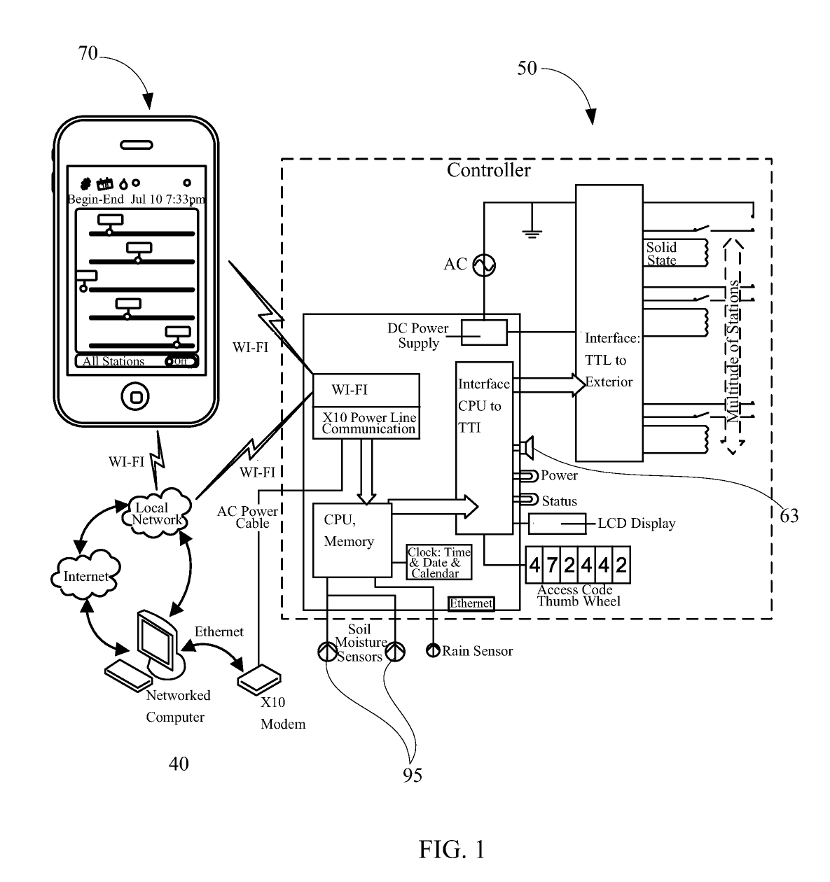

Turning now to FIG. 1, there is shown a block diagram watering system schematic of one possible configuration of the present invention. Generally, a remote computing device (generally indicated at 70), such as a smart phone, a mobile phone, a tablet, a laptop, a desktop, a home entertainment device, or a home gaming device, etc., communicates wireles sly with a controller (generally indicated at 50 and enclosed by the dashed line) that is physically connected to the irrigation stations of a water sprinkling system. The computing device 70 may communicate directly with the controller 50 or may be connected via a home network 40. If desired, in one configuration, the network computer 40 may be used to provide commands to the controller 50 without the use of the device 70. The computing device can communicate through protocols such as WiFi, X10, and the like. One with skill in the art will appreciate that any type of wireless protocol, such as Bluetooth, RF, etc., could be used and that any mention of WiFi, etc., throughout this application should be construed broadly to encompass all types of wireless protocols known in the art.

The computing device 70 (or alternatively the networked device 40) may set parameters for watering times and schedules, and also include considerations such as the weather report for the locality, obtained via the internet. The computing device is paired to the controller 50 through a unique access code, and the controller receives the information from the computing device wirelessly. The controller's software allows it to process inputs from the computing device, soil moisture sensors, etc., and send the correct output to the solenoids of the irrigation stations to which it is connected (described in more detail below). The controller provides electrical outputs which activate relays or transistors to power external irrigation solenoids, which are usually located in an enclosure under a lawn. The controller may also have the ability to access the Internet via the local network to receive weather predictions and suppress watering during predicted inclement weather, or enhance watering during especially inclement hot periods.

The user may use a home computer 40 as part of the network to control watering parameters. These parameters are relayed from a remote computing device via the internet and then via a home computer 40 to arrive at the controller. This may be useful for commercial applications that need to monitor a multitude of physical locations. In this configuration, a remotely located computing device connected to the internet issues commands to the local controller. Via the internet, a computing device has the ability to specify watering parameters for any one of multitude of locations, each equipped with a controller, by relaying commands between the remote computing device and the local WiFi-connected controller.

Commands to the controller may arrive wireles sly from a local computing device near the controller, or through other means such as via the electrical house wiring using a protocol such as X10, which is one protocol commonly used for power line wiring for signaling and control. Watering parameters may be relayed from a remote computing device via the internet and then via a home computer to arrive at the controller.

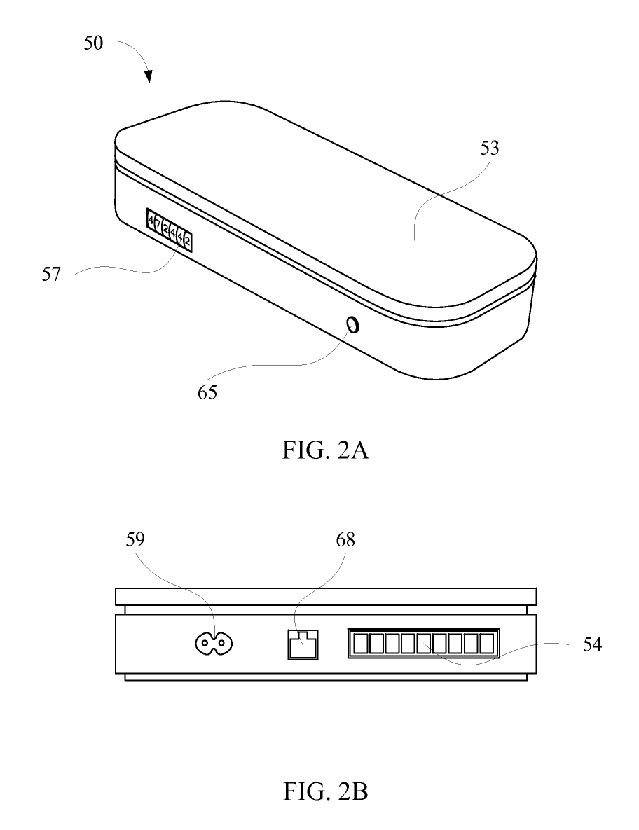

Turning now to FIG. 2, there is shown an example of a configuration for the hardware controller, generally indicated at 50. The controller 50 is at a location near the sprinkling system to be controlled. The controller 50 has a housing 53, which may be provided with an output strip of irrigation station terminals 54, to which the external water sprinkling system's actuators or transducers may be connected. Standard irrigation systems have actuators which are solenoids that start and stop the flow of water. Some irrigation systems may use solid state devices with the equivalent function. The controller, through its microprocessor (see FIG. 1), provides electrical outputs of specific AC voltage. The controller's output thus allows activation and deactivation of solenoids (or equivalent-function solid state devices) which control irrigation. Most modern lawn sprinkling solenoids need constant current at 24 volts AC to stay open for the watering time; others get a jolt of current to open, and a second jolt of current to shut when the watering is finished. The controller may be configured to work with any type of lawn sprinkling solenoid.

The outside of the controller 50 may be provided with a thumb wheel 57. This thumb wheel 57 allows the user to be able to set a unique access code 60. The access code is obtained from the remote computing device. With the access code paired or matched between the controller and the remote computing device, the controller is enabled to accept data that it receives over a Wi-Fi network, etc. The thumb wheel 57 on the controller 50, by way of example, may be a 6-digit multi-position rotary switch with a sprocket that is stepped forward or backward by rotating its six elements which represent the digits 0-9. With the access code 60 on the controller 50 paired to the remote computing device, the remote computing device may be used to control all irrigation stations attached to the terminals 54 of the controller 50. The controller may be provided with a sound transducer 63 to allow audio feedback. For example, the controller may beep continuously when it is not operating correctly, beep once when it has been paired to a remote computing device, etc.

The controller may be provided with an electrical cord to be plugged into a household socket, or an outlet 60 for plugging in a household cord to receive electrical power. In this configuration the controller would be powered by its household AC connection and require no battery. This configuration may also provide the advantage of not needing a back-up battery, as most standard sprinkling systems require, because the controller may receive its current time from the internet on power-up. Alternatively, the controller may be powered by batteries. The housing 53 contains the microprocessor, electronic circuitry, and non-destructive memory.

The front of the controller 50 may be provided with an LED light 65 which can display red, green, and yellow. The controller's software may specify which colors indicate the various statuses of the systems. For example, if the system is working correctly and is properly paired to receive input from a remote computing device, the LED light may be green. The controller may also be provided with an Ethernet port 68. A cabled Ethernet connection between the Wi-Fi router and the controller enables one-time setup of the controller's IP address. Alternatively, the controller 50 may be provided with near field communication technology, allowing the user to transfer internet IP parameters when the computing device is near the controller. When data are to be transmitted via X10 protocol, over household wiring, the Ethernet connection to the controller is also required as a one-time setup of the controller's IP address. The cabled Ethernet connection can also be used in a configuration in which a wireless operation is not desired, by using an X10 protocol modem. The controller 50 may be wall-mounted or placed on a horizontal surface.

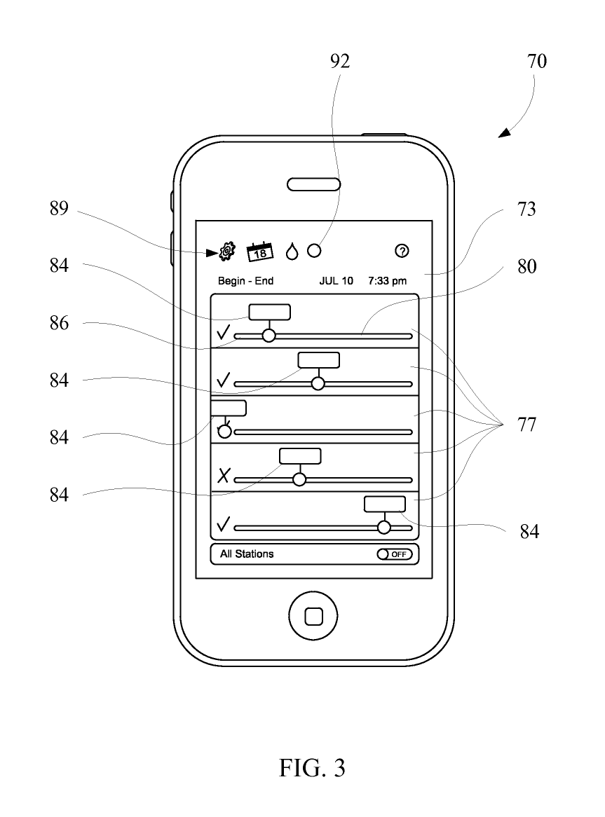

Turning now to FIGS. 3 through 10, there are shown exemplary interface screens to help understand the invention. It should be recognized that individual mobile devices, computers and other processors may have their own native screens or displays and methods that affect the look and organization of the interface. However, many of the principles remain the same. Additionally, although the screens are shown by way of example on a smart phone, any type of remote computing device with Wi-Fi or other types of wireless communication protocols such as Bluetooth, etc., may be used, such as mobile phones, tablets, laptops, desktops, home entertainment devices, home gaming devices, etc.

Turning to FIG. 3, there is shown an example of a station control screen 73 on a smart phone, generally indicated at 70. This station control screen 73 allows a user to set the start and stop times for watering at each irrigation station. There are many possible configurations for this screen, and many possible ways for the user to change the start and stop times for watering, and the configuration described herein is merely illustrative.

In this configuration of the station control screen 73, there are five slider windows 77, each slider window 77 corresponding to an irrigation station. Additional or fewer irrigation stations may be present, and one with skill in the art will appreciate that additional or fewer slider windows 77 may be present to correspond to the appropriate number of irrigation stations. Each slider window 77 may have a slider base line 80, indicating the hours in the day. Each slider window also may have a slider 84 which can be moved on and off the slider base line 80. By moving the slider 84 onto the slider base line 80, the user creates a slider watering line 86 along the slider base line 80. By extending the length of the slider watering line 86, the user extends the time of watering for that specific irrigation station. When the user shortens the length of the slider watering line 86, the length of watering time is decreased for that specific irrigation station.

For convenience in differentiating between the slider base line 80 and the slider watering line 86, the lines may appear as different colors and/or patterns. Additionally, the slider 84 may be provided with a display window that shows the start and stop times of the watering schedule (as in HH:MM-HH:MM, for example) or “OFF” to indicate that no watering schedule is selected.

Additionally, near the top of this screen, there may be a row of icons 89 to allow the user to skip from one screen to the next. Thus, the user does not have to cycle through a pre-set sequence of menu options and settings in order to encounter all the necessary settings for activating the device's functions. By way of example, there may be icons to skip to the calendar screen, the settings screen, etc. The top of the screen also shows a representation of an LED light 92. This LED light 92 mimics the LED light on the controller 50. Thus, if the controller is blinking yellow, the LED light 92 will also blink yellow to visually alert the user of the status of the controller. Additionally, if the controller is not communicating with the computing device, a message such as “Waiting for controller . . . ” may appear on the screen.

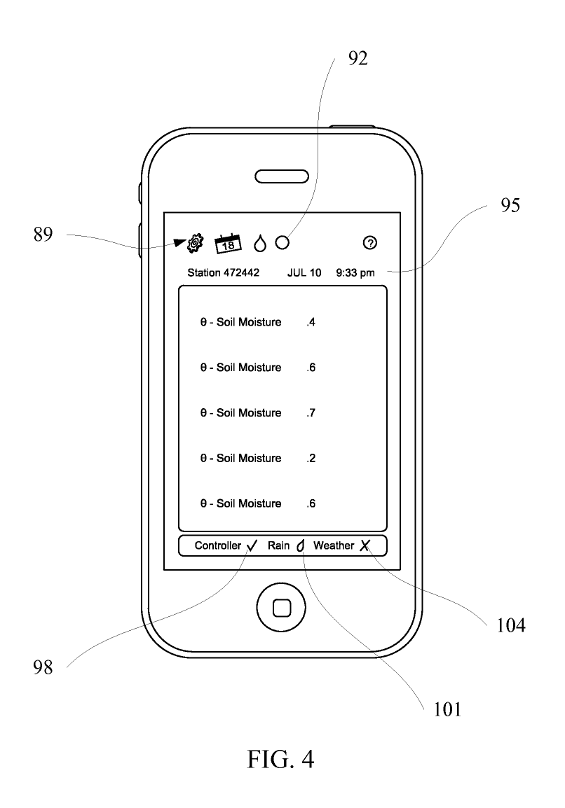

Turning now to FIG. 4, there is shown an example of a moisture display screen 95. If the water sprinkling system is equipped with moisture control sensors (95 in FIG. 1), the controller may receive an input from the soil moisture sensors and send the data to the computing device. On the moisture display screen 95, the soil moisture for each of the irrigation stations may be seen. Additionally, there is the row of icons 89 at the top of the screen to allow the user to skip to another screen. Along the bottom there may be provided icons to show if the controller is working (indicated by check 98), whether rain is predicted in the weather (indicated by raindrop 101), and whether the weather prediction has been obtained (as shown in FIG. 4, the weather prediction has not been obtained, indicated by “X” 104).

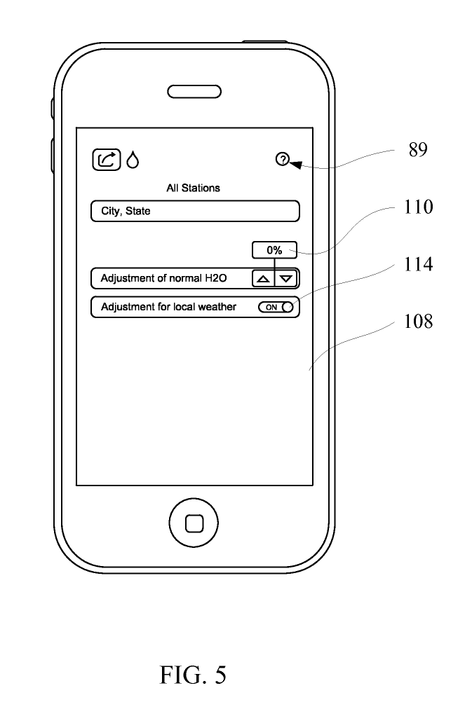

FIG. 5 illustrates an example of a possible physical location screen 108. This screen allows the user to modify all irrigation stations at a particular physical location. The controller may use the information from the physical location screen 108 to determine to local time for the location. Multiple physical locations may be controlled by one remote computing device, with each physical location having its own controller. The physical location screen 108 may be provided with a setting 110 to increase or decrease the specified watering time. Additionally, the screen 108 may be provided with an “ON/OFF” switch 114 to allow the user to either adjust for local whether or not, depending on what is desired.

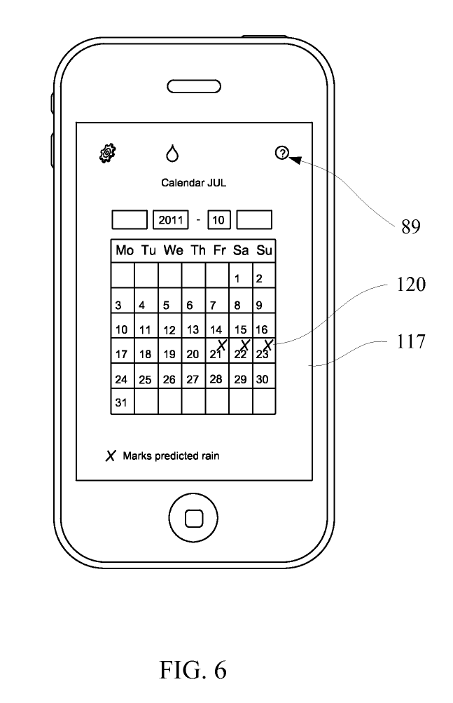

Turning now to FIG. 6, there is shown an example of a calendar screen 117. This screen 117, for example, could be used to provide a visual display to the user of dates where watering is scheduled, dates where watering is not scheduled, and dates where rain is predicted (for example, by the use of an “x” 120 in the corner of the date screen). The program could allow the user to easily select a given date and change the watering parameters for that date. Again, a row of icons 89 may be provided at the top of the screen to allow the user to easily switch between screens.

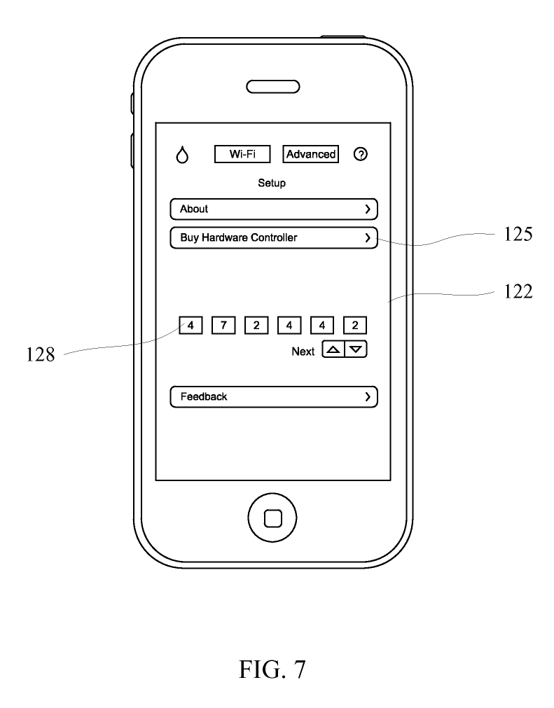

Turning now to FIG. 7, there is shown an example of a setup screen 122. This set up screen may provide the user with a link 125 to buy a hardware controller for their physical location (or multiple hardware controllers for multiple physical locations). This screen also may display an access code 128. This access code 128 is the code that is set on the hardware controller to allow the hardware controller and the remote computing device to be paired. This code also ensures that nearby controllers to not respond from signals from nearby computing devices, but rather only from signals from the specific computing device intended. The user may select additional access codes for additional hardware controllers (or reset the access code on their controller).

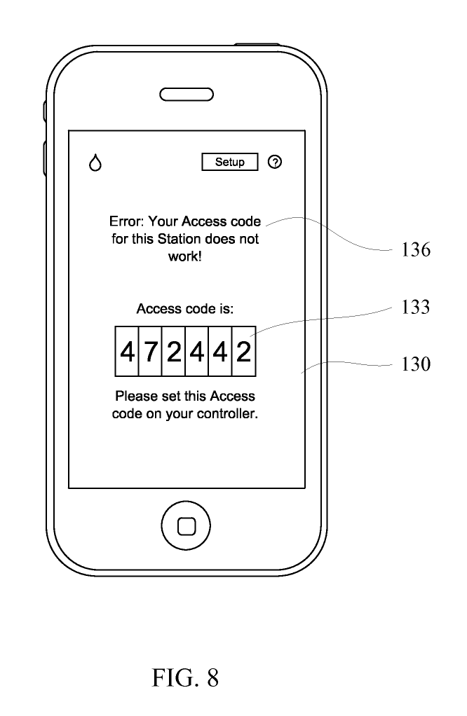

Turning now to FIG. 8, there is shown a possible access code error display screen 130. This error display screen may appear whenever the access code on the controller and the remote computing device do not match. If the controller uses a 6-digit thumb wheel, it may be helpful for this screen 130 to graphically display the access code as it would look on a 6-digit thumb wheel 133 to visually remind the user where the access code needs to be dialed. Additionally, the access code error display screen 130 may have a brief error message 136 to describe the problem to the user.

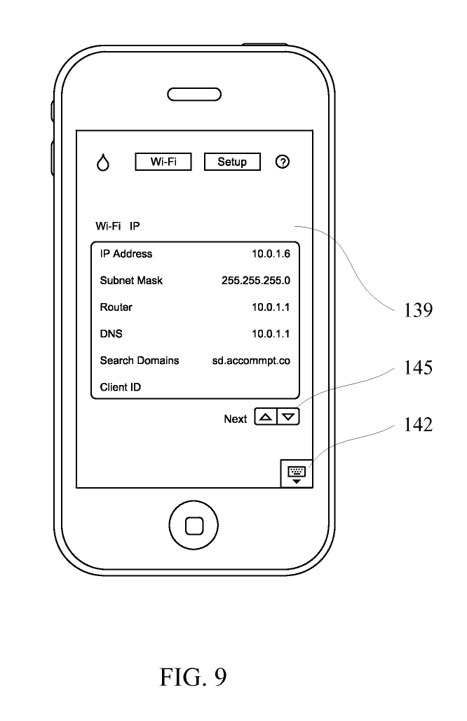

Turning now to FIG. 9, there is shown an example of a possible configuration for a Wi-Fi set-up screen 139. On this screen, internet parameters of the local Wi-Fi may be displayed. Initial parameters may be populated onto this screen by user input, and an icon 142 may be provided, for example, on a smart phone, etc., in order to activate the phone's native keyboard in order to facilitate input. In the alternative, a user-friendly way that these parameters may be obtained is by a one-time wired Ethernet connection between a home computer and the controller to allow automatic gathering of these data. Several networks may be entered and displayed using the arrows 145 provided.

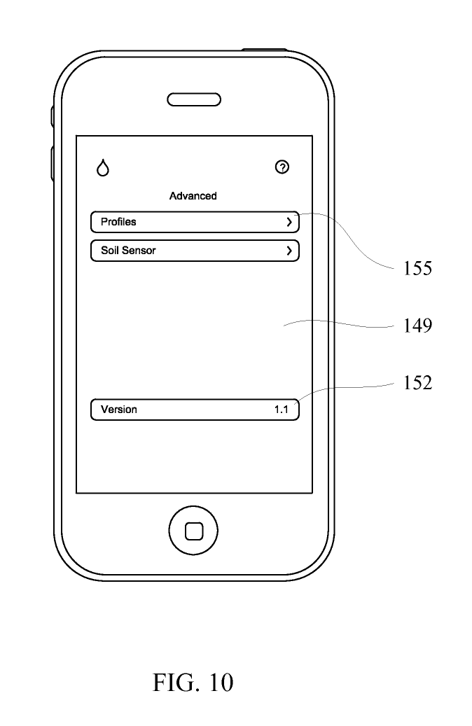

Turning now to FIG. 10, there is shown an example of an advanced setup screen 149. By way of example, this screen may allow users to activate or deactivate optional soil moisture sensors. This screen may also display the current software version number 152 that is running on the system. The version number for the computing device and the controller should always be the same. A provision, Profiles 155, may be provided whereby a watering profile for a physical location may be named by the user for later printed recall. A watering profile may be a list of data and dates and actions, which can be culled from the message file for printout on paper. Such a printed report can show which stations were activated by the controller in the past and which dates and actions still lie in the future.

If a user employs a smart phone, cellular phone, or other device capable of messaging services (such as SMS or MMS), the user may select to have messages automatically sent up certain events. For example, the user may select to have a message sent when watering begins at an irrigation station and when watering ends at an irrigation station.

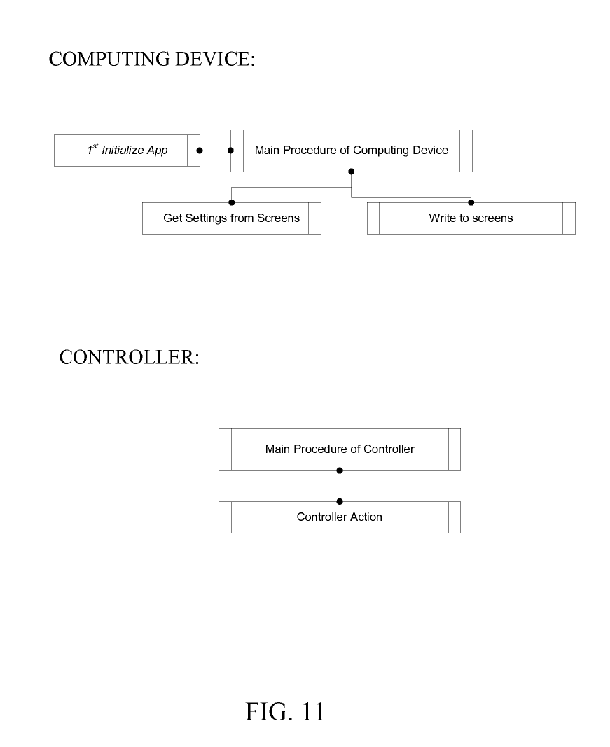

One having skill in the art appreciates that there are various ways to configure the software of the present invention. By way of example, FIGS. 11 through 17 show flowcharts of the logic of the software that may be used in one possible configuration. FIG. 11 shows the overall logic on the remote computing device and on the controller and how they are connected. The box symbols with the double lines on the left and right are sub-routines that are shown on separate figures (described hereafter) and are performed from those places in the overall logic.

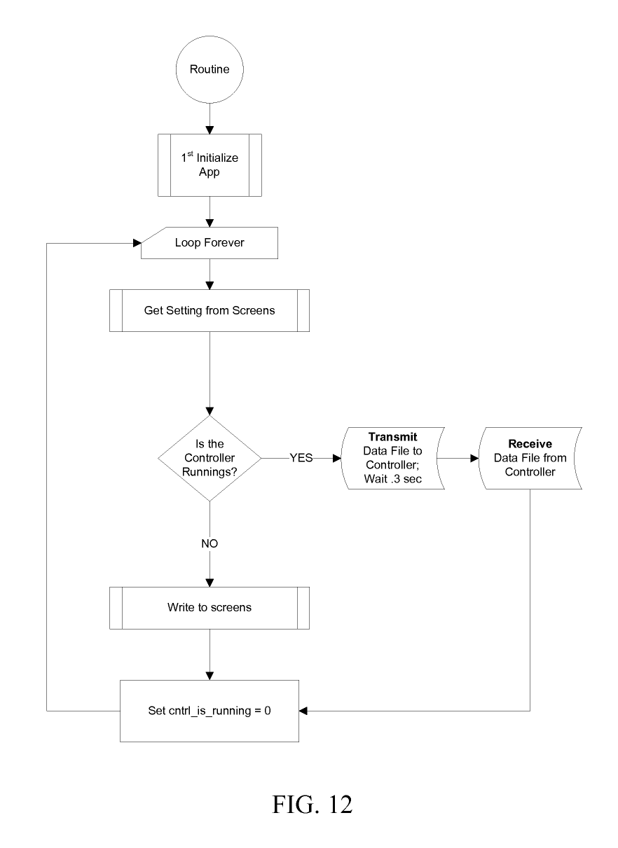

FIG. 12 shows the logic of the main procedure of the computing device. The following pseudo code provides an example of software instructions which may be executed by hardware such as the computing device in order to implement the main procedure of the computing device.

| Start Procedure | |
|---|---|
| Perform Routine: 1st Initialize App | ----------- On power-up of |

Controller -----------
Loop forever

Perform Routine: Get Settings from Screens
If cntrl_is_running = 1

Transmit Data File to Controller and Wait 3 sec.
Receive Data File from Controller

End-if
Perform Routine: Write to screens
Set cntrl_is_running = 0

End-loop
End Procedure

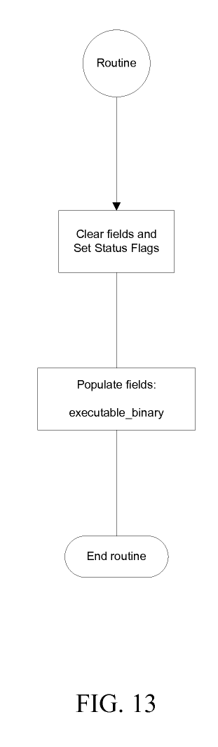

FIG. 13 shows the logic of the first initialization of the application on the computing device. The following pseudo code provides an example of software instructions which may be executed by hardware such as the computing device in order to implement the 1st initialize app routine of the computing device.

Start Routine
Set cntrl_is_running to 0
Set now_watering to 0
Set off-now to 1
Set adj_local_weather to 0
Set wi_fi_data to blanks
OVERLAY executable_binary onto executable binary in controller's
memory
End Routine

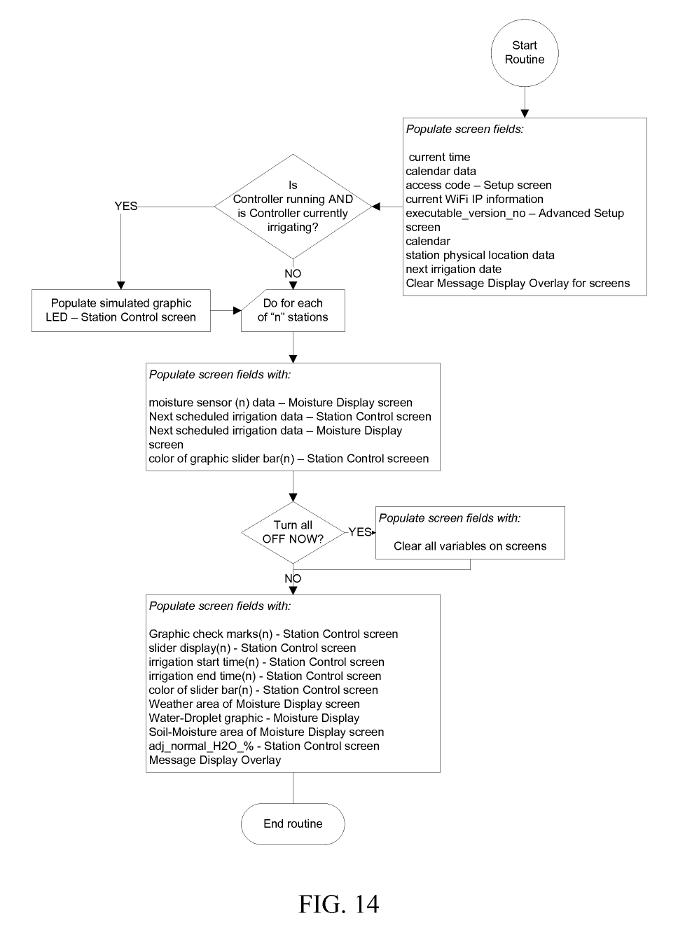

FIG. 14 shows the logic of the computing device writing to screens. The following pseudo code provides an example of software instructions which may be executed by hardware such as the computing device in order to implement the write to screens routine of the computing device.

Start Routine
Populate current time onto all screens
Populate access_code onto Setup screen (see FIG. 7)
Populate wi_fi(x) currently used onto WiFi Setup screen (see FIG. 9)
Populate executable_version_no onto Advanced Setup screen (see FIG. 10)
Populate calendar onto Calendar of Watering Schedule screen (see FIG. 6)
Populate station_city onto Station City from Physical Location screen (see FIG. 5)
Clear and hide Message Display Overlay (not shown)
Set cntrl_msg_1, cntrl_msg_2, cntrl_msg_3, and cntrl_msg_4 to BLANK
If cntrl_is_running = 1 AND now_watering = 1

Display a simulated GRN LED on Moisture Display screen (see FIG. 4) and on
Station Control screen (see FIG. 3)

End-if
For n = 1 to 5

Display moisture_sensor(n) data on Soil-Moisture area of Moisture Display
screen (see FIG. 4)
Display day of week(n) on Soil-Moisture area of Station Control screen (see FIG.
3) --- Calendar
Set color of slider bar (n) to BLU
If off_now = 1

Set RED check “X” (n) on line-item on Station Control screen (see FIG. 3)
Populate slider display window (n) with ‘OFF‘
Move slider (n) to leftmost HOME position
Populate ‘0%’ to display window on Physical Location screen (see FIG. 5)

Else

Set BLU check marks(n) on line-item on Station Control screen (see FIG.
3)
Populate slider-display-window (n) with h2o_start_time(n) ‘ -- ‘,
h2o_end_time(n)
Color slider bar GRN between positions representing start time and end
time

End-if

End-for
If adj_local_weather = 0

Set Adjust for Local Weather slider switch to OFF on Physical Location screen
(see FIG. 5)
Set RED “X” on Weather area of Moisture Display screen (see FIG. 4)

Else

Set Adjust for Local Weather slider switch to ON

End-if
If rain_sensor = 1

Display rain_sensor as BLU Water-Droplet on Moisture Display screen (see FIG.
4)

If rain_sensor NOT = 1

Display ‘NO’ on Moisture Display screen

Display moisture_sensor data onto Soil-Moisture area of Moisture Display screen (see
FIG. 4)
Move 0% from Display window on Physical Location screen (see FIG. 5) to
adj_normal_H20_%
If Non-BLANK,

Move cntrl_msg_1, cntrl_msg_2, cntrl_msg_3, and cntrl_msg_4 onto Message
Display Overlay (not shown)

End Routine

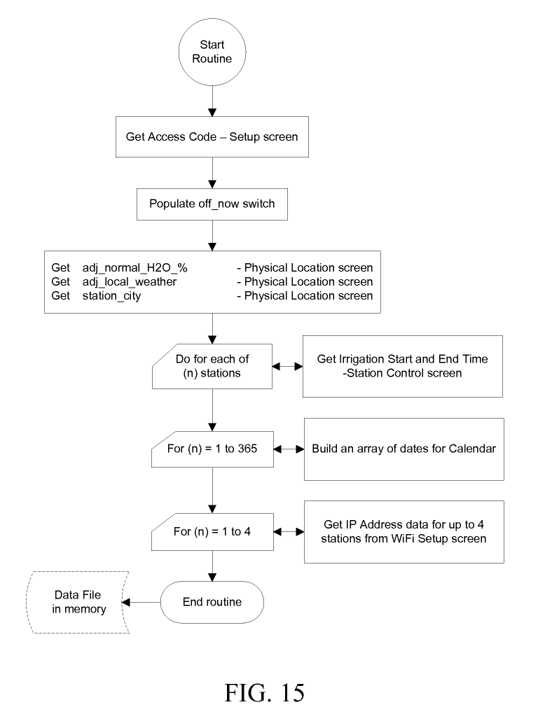

FIG. 15 shows the logic of the computing device getting settings from screens (such as the touch screens of smart phones). The following pseudo code provides an example of software instructions which may be executed by hardware such as the computing device in order to implement the get settings from screens routine of the computing device. One with skill in the art would appreciate that while some values are set for “n”, may different values may be used within the scope of the invention.

Start Routine
Get Access Code from Setup screen and Move to access_code
If All Stations Off switch is set to ‘OFF’ on Station Control screen (see
FIG. 3)

Set off_now = 1

Else

Set off_now = 0

End-if
Get adj_normal_H20_% from display window of Physical Location
screen (see FIG. 5)
Get adj_local_weather from Physical Location screen (see FIG. 4)
Get station_city from Physical Location screen (see FIG. 5)
For n = 1 to 5

Get h2o_start_time(n) from slider -- 0 to 24 hrs -
Get h2o_end_time(n) from slider -- 0 to 24 hrs --

End-for
For n = 1 to 365

Move Day(n) of Calendar screen to days_array(n)

End-for
------------ Get WiFi parameters from WiFi Setup screen ---------------
Move Blanks to wi_fi_data
For n = 1 to 4

Get IP Address, Subnet Mask, Router, DNS,
Search Domains, and Subnet Mask, and move to wi_fi(n)

End-for
End Routine

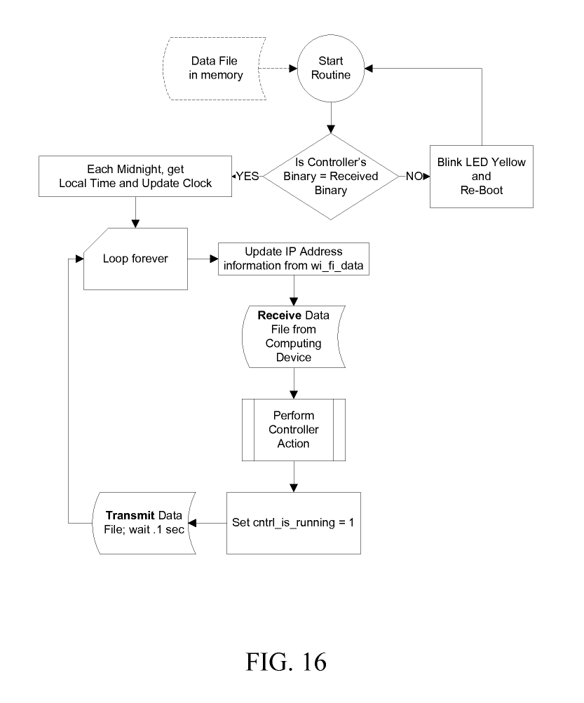

Turning now to FIG. 16, there is shown the logic of the main procedure of the controller. The following pseudo code provides an example of software instructions which may be executed by hardware such as the controller in order to implement the main procedure of the controller.

Start Procedure
Blink Controller's LED: RED for one second ----- On power-up of Controller -----
----------------------- Check for matching software version -----------------------------
If executable_version_no NOT = executable's version number in MEMORY now

OVERLAY executable_binary onto executable binary in cController's memory
Blink Controller's LED: YEL for one minute
RE-BOOT Controller

End-if
---------------------- Reset the Controller clock once per day --------------------------
If time = 23:59 OR if first power-up

Get local time and date for station_city from Internet and populate

current time of Controller's clock
current day of Controller's clock
current mo of Controller's clock
current yr of Controller's clock

Update the Controller CLOCK

End-if
Loop forever

BLANK out cntrl_msg_1, cntrl_msg_2, cntrl_msg_3, and cntrl_msg_4
Save access_code from this iteration
Get access_code from Controller Thumb Wheel
Receive Data File from Computing Device
------------------- Re-set Controller clock and -----------------------
Populate IP Address, Subnet Mask, Router, DNS, Search Domains, and Client ID
from wi_fi_data, and select an available WiFi network
If wi_fi(1) = Blank

Set adj_local_weather to 0 ---- Override ----
Move

‘Controller is unable to connect to the Internet...’
‘Adjusting for local weather is not possible’ to cntrl_msg_2

Transmit Data File and Wait .5 sec

End-if
If access_code NOT = Access Code from this iteration

Move ‘Please match Access Code on your Controller’ to cntrl_msg_3

End-if
Perform Routine Controller Action
Set cntrl_is_running to 1
Transmit Data File and Wait .1 sec

End-loop
End Procedure

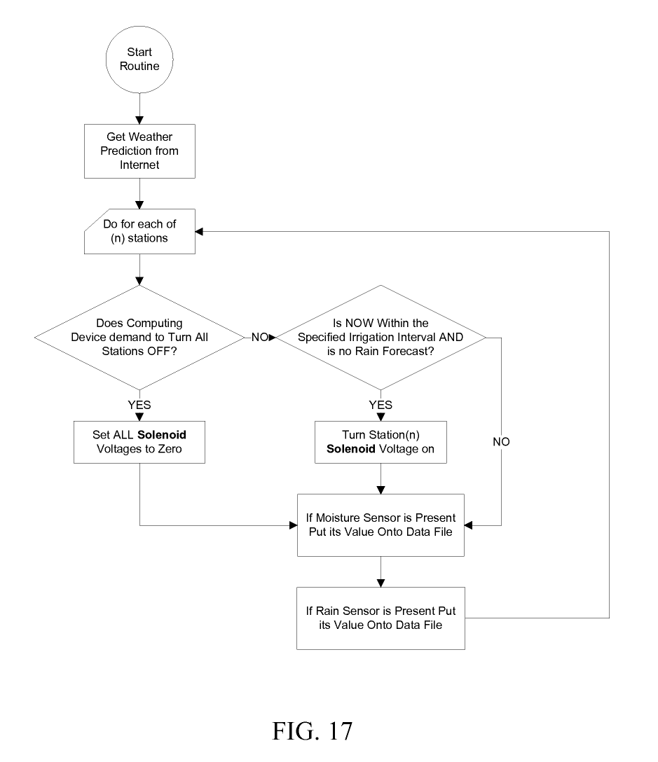

FIG. 17 shows the logic of the controller action. The following pseudo code provides an example of software instructions which may be executed by hardware such as the controller in order to implement the controller action of the controller.

Start Routine
----------------- Check to see if it's raining and if it will rain ----------------------
If adj_local_weather = 1

Get weather prediction from Internet for station_city for today's calendar date.

If NO weather prediction from Internet

Move “Controller is unable to find weather prediction for station_city on the
Internet” to cntrl_msg_4
Transmit Data File and Wait 2 sec.

End-if
For n = 1 to 5

If off-now = 1

Set all 5 output voltages to 0
Illuminate Controller LED: YEL
Set now_watering = 0

Else

IF days_array(TODAY) = 1
AND current clock time >= h2o_start_time(n)
AND current clock time <= h2o_end_time(n)
AND rain_sensor = 0
AND Calendar does NOT forecast rain for NOW --- Local weather
-----Turn station output power (n) ON --- Activate sprinkler ---
Set Controller LED: GRN
Set now_watering = 1

End-if

End-if
Populate moisture_sensor(n)with value of Controller's moisture sensor(n)

End-for
Populate rain_sensor with status of Controller's rain sensor to 1=Rain, 0=No rain
Illuminate Controller LED: GRN
End Routine

One having skill in the art would appreciate that modifications could be made to the logic of these flowcharts and still be within the scope of the present invention.

The following pseudo code shows an example of software instructions which may be executed by hardware such as the controller in order to implement a message record layout of the controller. By way of example, the binary code is shown as 8K, but one with skill in the art would appreciate that it may be larger or smaller.

Level 1:

| access_code | | 06 | digits numeric, for location |
|---|---|---|---|
| cntrl_is_running | | 01 | 0/1 (0 = no hardware ; 1= hardware Controller is has |
| power) | | | |
| cntrl_msg_1 | | 40 | error message |
| cntrl_msg_2 | | 40 | error message |
| cntrl_msg_3 | | 40 | error message |
| cntrl_msg_4 | | 40 | error message |
| now_watering | | 01 | The Controller is now watering |
| off-now | | 01 | 1=set all stations off now |
| rain_sensor | | 01 | 0/1 1=it's raining; 0=no rain |
| time_offset | | 02 | Hours; time offset of remote location from local time |
| adj_normal_H20_% | | 02 | percent |
| adj_local_weather | | 01 | 1= adjust for local weather |
| days array | | 365 | n, n, ...n |
| station_city | | 30 | |
| | STATION #1: | | 1^{st} of 5 H₂O-stations |

| | | |
|---|---|---|
| off_now(1) | 01 | overrides Controller timing |
| h2o_start_time(1) | 13 | YYYY,MM,DD,HH,MM,S |
| h2o_end_time(1) | 06 | HH,MM,SS |
| moisture_sensor(1) | 02 | H₂O content of soil; θ-value .01 - 1.0 |

| | |
|---|---|
| . | |
| . | 2nd, 3rd, 4th STATIONS... |

.

| | |
|---|---|
| STATION #5: | 5^{th} of 5 H₂O-stations |

| | | |
|---|---|---|
| off_now(5) | 01 | overrides Controller timing |
| h2o_start_time(5) | 13 | YYYY,MM,DD,HH,MM,S |
| h2o_end_time(5) | 06 | HH,MM,SS |
| moisture_sensor(5) | 02 | H₂O content of soil; θ-value .01 - 1.0 |

Binary Executable Code:
Controller Software resides in Computing Device's Memory
The software Binary for the Controller is embedded within the software for the Computing Device. The first six bytes in the memory of area for the Controller software contains the software version number:

| | | |
|---|---|---|
| Level 1: | executable_binary 8K. | Binary code of Controller |

Level 2 Redefines Level 1.

| Level 2: | executable_version_no 06. The software version number | | |
|---|---|---|---|
| WI-FI: | | | |
| Level 1: | wi_fi_data | 400 | WiFi parameters - Up to 4 networks |

Level 2 Redefines Level 1.

| | | | |
|---|---|---|---|
| Level 2: | wi_fi(1) | 100 | fields for: IP Address, Subnet Mask, |
| | | | Router |
| | wi_fi(2) | 100 | DNS, Search Domains, and Client ID |
| | wi_fi(3) | 100 | for 3rd WiFi network |
| | wi_fi(4) | 100 | for 4th WiFi network |

The controller may employ a useful method for ensuring that its software is updated to the most recent version of software that is loaded onto the computing device. When software from the remote computing device is first loaded or updated to a new version, a binary executable code (see above) is also obtained for the controller as part of the software. This binary executable code is the computer code which runs the hardware controller. The controller's software and its binary executable code reside in the message record and are copied to the memory of the controller. In order to ascertain that the latest software is always present in the controller, the binary executable code constantly circulates between the computing device and the controller as a component of the message record. If a newer version of the software is detected by the controller, the controller overlays said new version of the binary executable code onto the old version in its memory as indicated in the pseudo. If a newer software version is encountered by the controller, its software re-boots the controller.

There is thus disclosed an improved system for remotely controlled water sprinkling and its method of use. One with skill in the art will appreciate that the principles taught herein may be applied to various kinds of electrical devices such as electric door openers, fans, home lighting, etc. It will be appreciated that numerous changes may be made to the present invention without departing from the scope of the claims.

What is claimed is:

1. A method for remotely controlling a sprinkling system comprising:
a computing device capable of sending information remotely via wireless communication protocol;
at least one controller, the controller being comprised of an input port for receiving information from at least the computing device, a microprocessor, and an output port for providing an electrical current to at least one irrigation solenoid; and
entering inputs for watering schedules on the computing device.

2. The method according to claim 1, wherein the method further comprises pairing the computing device and the controller by setting a matching access code on the computing device and the controller.

3. The method according to claim 1, wherein the computing device is selected from the group of smart phones, mobile phones, tablets, laptops, desktops, home entertainment devices, and home gaming devices.

4. The method according to claim 1, wherein the controller may access the internet and wherein the method further comprises the controller accessing the internet to check for local weather reports, the controller receiving the weather reports on the input port, the controller processing the weather reports through the microprocessor, and the controller sending an electrical current on the output port to at least one irrigation solenoid based on the local weather report processed.

5. The method according to claim 4, wherein the microprocessor of the controller is programmed to suppress watering in response to rain predicated in the local weather report and increase watering time in response to hot temperatures predicted in the local weather report.

6. The method according to claim 1, the method further comprising more than one sprinkling system at more than one physical location, wherein the more than one sprinkling system may be controlled by the computing device, each of the more than one physical locations having at least one controller.

7. The method according to claim 1, wherein the computing device comprises software with inputs for multiple irrigation stations.

8. The method according to claim 7, wherein the controller comprises at least one output port for each of the multiple irrigation stations.

9. The method according to claim 7, wherein the software of the computing device sends a binary code to the controller, the binary code designating the latest version of the software of the computing device, and the controller automatically updating its version of the software whenever a newer version of software on the computing device is detected.

10. The method according to claim 1, the method further comprising:
the computing device sending the inputs for watering schedules remotely via the internet to the at least one controller; the at least one controller receiving the inputs for watering schedules on its input port and processing the inputs for watering schedules on the microprocessor, and providing electrical currents to at least one irrigation station to implement the inputs received for watering schedules.

11. An apparatus for providing remote control of a water sprinkling system, the apparatus comprising:
an input port for receiving and storing information regarding water scheduling times, the information including at least a desired start time and stop time for irrigation;
a microprocessor connected to the input port and an output port; and
the output port for sending an electrical signal to at least one irrigation station.

12. The apparatus according to claim 11, wherein the apparatus further comprises a second input port for receiving and storing information regarding soil moisture sensor readings.

13. The apparatus according to claim 11, wherein the apparatus further comprises a Wi-Fi chip, USB port, Ethernet port, or other means for sending information wirelessly.

14. A system for remotely controlling irrigation systems, the system comprising:
a computing device with Wi-Fi or Internet capabilities to send information; and
at least one controller with an input port for receiving information from the computing device, an output port for sending electrical signals to at least one irrigation station, and a microprocessor connected to the input port and output port.

15. The system according to claim 14, further comprising at least two controllers located at at least two physical locations, and wherein each of the at least two controllers comprises a unique access code, and wherein the computing device may be programmed to pair to each unique access code.

16. A computer program product comprising a computer readable storage medium to store a computer readable program that, when executed on a computer, causes the computer to perform operations for remotely controlling a sprinkling system, the operations comprising:
receiving an input from a user at a computing device, wherein the input comprises an instruction for remotely controlling a controller of the sprinkling system;
transmitting the instruction from the computing device to the controller; and
receiving at the computing device feedback information from the controller, wherein the feedback information indicates a status of at least one operating condition at the controller.

17. The computer program product according to claim 16, wherein the operations further comprise:
receiving a pairing input from the user at the computing device, wherein the pairing input comprises an access code to match a corresponding access code of the controller;
enabling a communication of the access code of the computing device or the corresponding access code of the controller between the computing device and the controller; and
pairing the computing device with the controller in response to verification of a match between the access code of the computing device and the corresponding access code of the controller.

18. The computer program product according to claim 16, wherein the operations further comprise:
accessing a local weather report via the internet; and
transmitting the instruction from the computing device to the controller in response to a parameter of the local weather report meeting a sprinkler adjustment criteria.

19. The computer program product according to claim 16, wherein the operations further comprise sending instructions from the computing device to a plurality of controllers to control a corresponding plurality of sprinkling systems.

20. The computer program product according to claim 16, wherein the operations further comprise:
displaying a station control screen on a user interface of the computing device, wherein the station control screen is configured to visually display parameters of a watering schedule for a plurality of watering stations controlled by the controller; and
receiving the input from the user to adjust at least one of the parameters of the watering schedule.
